(19) United States
(12) Patent Application Publication
(10) Pub. No.: US 2009/0222837 A1
(43) Pub. Date: Sep. 3, 2009

(54) WORK FLOW MANAGEMENT SYSTEM AND WORK FLOW MANAGEMENT METHOD

(75) Inventor: Yasuo SUGAHARA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/391,633

(22) Filed: Feb. 24, 2009

(30) Foreign Application Priority Data
Feb. 28, 2008 (JP) 2008-047917

(51) Int. Cl. G06F 9/50

(52) U.S. Cl. 718/105

(57) ABSTRACT

A work flow management method is executed by a system including a person-in-charge terminal, and a management device, wherein the person-in-charge terminal receives n input of information containing a value requested for decision through an operation by a person in charge, transmits the input information as application information to the management device, and receives result information of an examination about the application information from the management device, and the management device notifies a decider of the application information received from the person-in-charge terminal, receives an input of the result information containing a range in which at least the application information can take a value when approving the application information through the operation of the decider; and transmits the result information to the person-in-charge terminal.

### CROSS-REFERENCE OF RELATED APPLICATION

This application is based upon and claims the benefit of priority of the prior Japanese Patent Application No. 2008-047917, filed on Feb. 28, 2008, the entire contents of which are incorporated herein by reference.

### FIELD

The embodiment relates to a technology of managing information on an item of discussion (which will hereinafter be termed a “work”).

### BACKGROUND

Business activities, especially business negotiations with corporations, involve conducting discussions based on a scale of the business negotiation, a share of company's products, a state of competition with other companies, etc, and determining final transaction conditions (e.g., a price and a deadline of delivery date) in many cases. On this occasion, in the case of a work exceeding a discretion assigned to a person in charge of sales, for example, if [discount] is required, there arises a necessity for consulting with a [leader] or a [responsible person] having authority of decision about flexibility of a transaction. Generally, the work consultation is conducted in the following procedures.

1) Occurrence of work (item for discussion): After showing an initial estimate, if a further discount is requested by a customer and when judging from a state of the competitions that the discount be indispensable, the occurrence of work is applied to these cases.

2) Collection of information: Information research is performed by a method such as hearing, from the customers, the company information of the customers, the state of competitions, and an operating situation of the company's products.

3) Work application: A decider is informed of an inpresentation estimate, a requested price and various items of collected information, and is requested to make a decision about the work.

4) Examination of work: The decider determines the final price by taking account of a cost price of a commercial material, a state of stock, a market trend and company's tactics.

5) Notification of result: A reply of the decided price is given to the person in charge of the sales.

6) Progress of negotiation: The person in charge of the sales proceeds with the negotiation within the range of the decided price.

Moreover, the following Patent documents disclose the technologies as the prior arts related to the invention of the present application.

[Patent document 1] Japanese Patent Laid-Open Publication No. 2003-122909

[Patent document 2] Japanese Patent Laid-Open Publication No. 2002-259641

### SUMMARY

The conventional consultation methods for the work have the following problems.

1) A time-consuming application: Various items of information are required to be collected and documentized for making the application for the work, which leads to a large burden on the person in charge of the sales.

2) A time-consuming examination: The work examination is required to be conducted by referring to the various items of information, and hence a large burden is applied onto the decider.

3) An amount of discount unguaranteed: Finally, there is no guaranty for the person in charge of the sales to conduct the negotiation within the decided price range. Even if a discount equal to or larger than an applied amount of money is made deliberately or by an operational mistake, there is no method for stopping acceptance of the order.

4) Disability to follow up a change: Even when a composition and a quantity of the commercial article changes after the decision, the negotiation proceeds as it is, and hence there is a case of receiving the order showing different contents of the decision.

5) An unknown relation with the actual negotiation: Specifically, it is unknown which work reaches the acceptance of the work, and it is therefore difficult to manage and analyze the works.

To accomplish the object, a work flow management system comprises:

a person-in-charge terminal; and

a management device,

the person-in-charge terminal including:

an input unit receiving an input of information containing a value requested for decision through an operation by a person in charge;

an application unit 32B transmitting the input information as application information to the management device; and

a result receiving unit 32C receiving result information of an examination about the application information from the management device,

the management device including:

a notifying unit 12A notifying a decider of the application information received from the person-in-charge terminal;

a result accepting unit 12B receiving an input of the result information containing a range in which at least the application information can take a value when approving the application information through the operation of the decider; and

a result transmitting unit 12C transmitting the result information to the person-in-charge terminal.

### BRIEF DESCRIPTION OF THE DRAWINGS

FIG. 1 is a schematic diagram of a work flow management system.

FIG. 2 is a schematic diagram of a work consultant server.

FIG. 3 is a schematic diagram of an order accepting server.

FIG. 4 is a schematic diagram of a person-in-charge terminal.

FIG. 5 is a schematic diagram of a decider terminal.

FIG. 6 is a schematic diagram of a data server.

FIG. 7 is an explanatory diagram of a negotiation management DB.

FIG. 8 is an explanatory diagram of a customer management DB.

FIG. 9 is an explanatory diagram of a commercial article information DB.

FIG. 10 is an explanatory diagram of an enterprise information DB.

FIG. 11 is an explanatory flowchart of a work flow management method.

FIG. 12 is an explanatory flowchart of the work flow management method.

FIG. 13 is an explanatory flowchart of the work flow management method.

FIG. 14 is an explanatory flowchart of the work flow management method.

FIG. 15 is a diagram showing one example of an application information input form.

FIG. 16 is a diagram showing an example of a prompt message for application.

FIG. 17 is a diagram showing one example of a decider table.

FIG. 18 is a diagram showing a display example of the application information when examined.

FIG. 19 is a diagram showing a display example of the application information when examined.

FIG. 20 is a diagram showing a display example of result information.

FIG. 21 is a diagram showing a display example of the search result.

### DESCRIPTION OF EMBODIMENT(S)

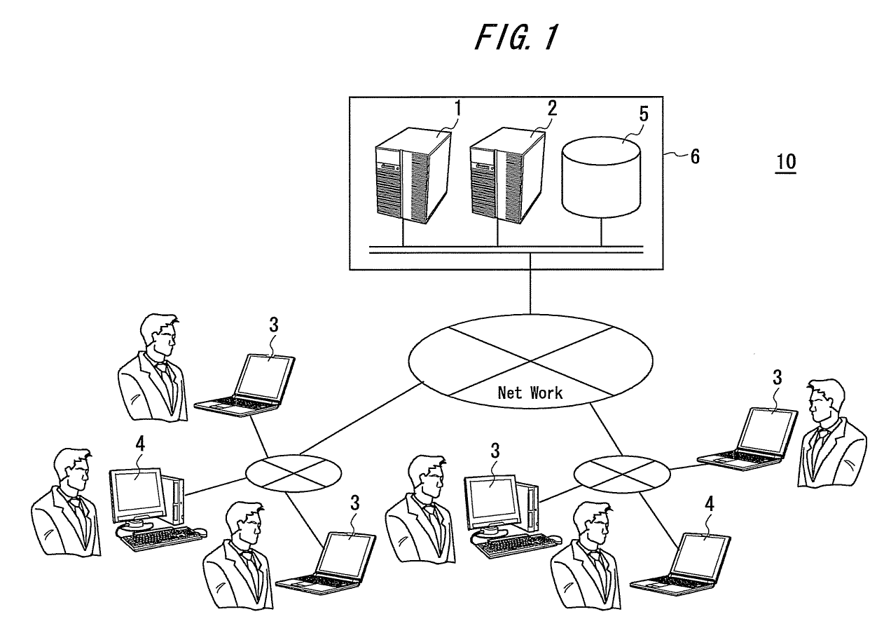

FIG. 1 is a schematic view of a work flow management system 10.

The work flow management system 10 includes a work (item for discussion) consultant server 1, an order accepting server 2, a person-in-charge terminal 3, a decider terminal 4 and a data server 5. The work consultant server 1, the order accepting server 2 and the data server 5 build up a management device 6 of the present system 10.

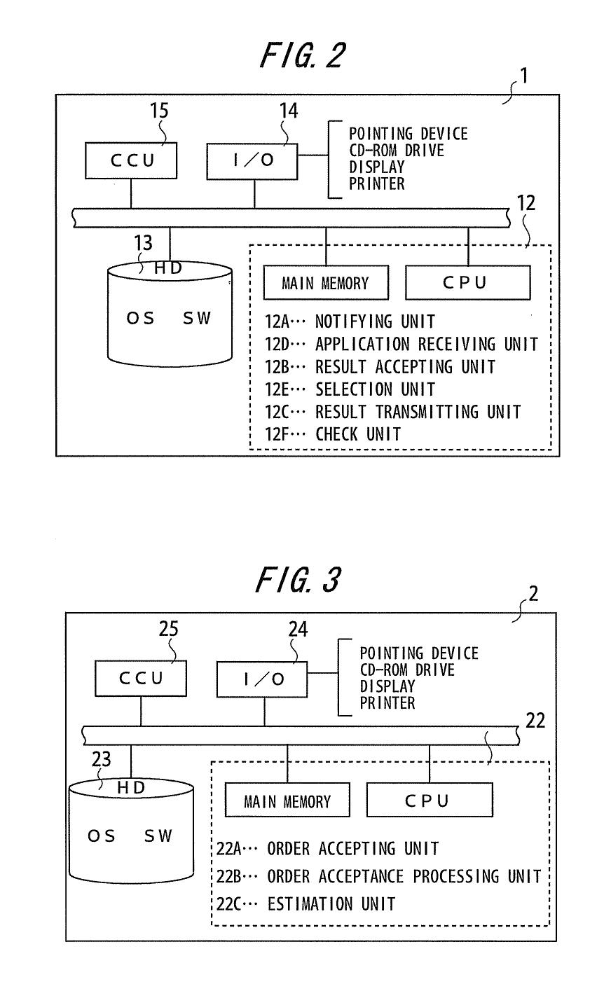

FIG. 2 is a schematic view of the work consultant server 1. The work consultant server 1 is a computer including an arithmetic processing unit 12, a storage unit (hard disk) 13 stored with data and software for the arithmetic process, an input/output (I/O) port 14, a communication control unit (CCU) 15, etc. Properly connected to the I/O port 14 are input devices such as a keyboard, a mouse and a CD-ROM drive and also output devices such as a display device and a printer.

The CCU 15 controls communications with other computers via a network.

The storage unit 13 is preinstalled with an operating system (OS) and application software (a work flow management program).

The arithmetic processing unit 12 configured of a CPU (Central Processing Unit), a main memory, etc properly reads the OS and the application program from the storage unit 13 and executes the OS and the application program, and arithmetically processes pieces of information inputted from the I/O port 14 and the CCU 15 and the information read from the storage unit 13, thereby functioning also as a notifying unit 12A, a result accepting unit 12B, a result transmission unit 12C, an application receiving unit 12D, a selection unit 12E and a check unit 12F.

The notifying unit 12A notifies the decider terminal 4 of application information received from the person-in-charge terminal 3.

The result accepting unit 12B receives result information as a result of an examination by a decider from the decider terminal 4. Note that if the result shows that the application information is approved, the result information contains at least a range in which values of the items of application information can be taken.

The result transmission unit 12C transmits the result information to the person-in-charge terminal 3.

The application receiving unit 12D receives the application information via the order accepting server 2 from the person-in-charge terminal 3.

The selection unit 12E selects the decider conforming to the application information by referring to a decider table in which a plurality of deciders is registered, and transmits the application information to the decider terminal 4 of the (selected) decider.

The check unit 12F receives status information from the decider terminal 4, and determines whether or not the decider selected based on the status information by the selection unit 12E can decide the application information.

FIG. 3 is a schematic diagram showing the order accepting server 2. The order accepting server 2 is a computer including an arithmetic processing unit 22, a storage unit (hard disk) 23 stored with data and software for the arithmetic process, an input/output (I/O) port 24, a communication control unit (CCU) 25, etc.

Properly connected to the I/O port 24 are the input devices such as the keyboard, the mouse and the CD-ROM drive and also the output devices such as the display device and the printer.

The CCU 25 controls the communications with other computers via the network.

The storage unit 23 is preinstalled with the operating system (OS) and application software (a security information notifying program).

The arithmetic processing unit 22 constructed of the CPU (Central Processing Unit), the main memory, etc properly reads the OS and the application program from the storage unit 23 and executes the OS and the application program, and arithmetically processes pieces of information inputted from the I/O port 24 and the CCU 25 and the information read from the storage unit 23, thereby functioning also as an order accepting unit 22A, an order acceptance processing unit 22B and an estimation unit 22C.

The order accepting unit 22A receives order information from the person-in-charge terminal 3.

The order acceptance processing unit 22B refers to the result information associated with the order information and identifying information of order settlement information, and executes an order accepting process within a range of a value of the result information. Further, the order acceptance processing unit 22B, when receiving from an ordering unit 32E of the person-in-charge terminal 3 a change signal (e.g., the order settlement information) purporting that a value of the application information is changed, executes an order accepting process if a value to be modified is within the result information range, but inhibits the order accepting process if the value to be modified is beyond the result information range.

The estimation unit 22C, when receiving an estimation request from the person-in-charge terminal 3, reads the application information associated with the identifying information of the estimation request from a database 52, and lays out the respective items thereof in a predetermined written estimate format, thus generating written estimate data (a written estimate file).

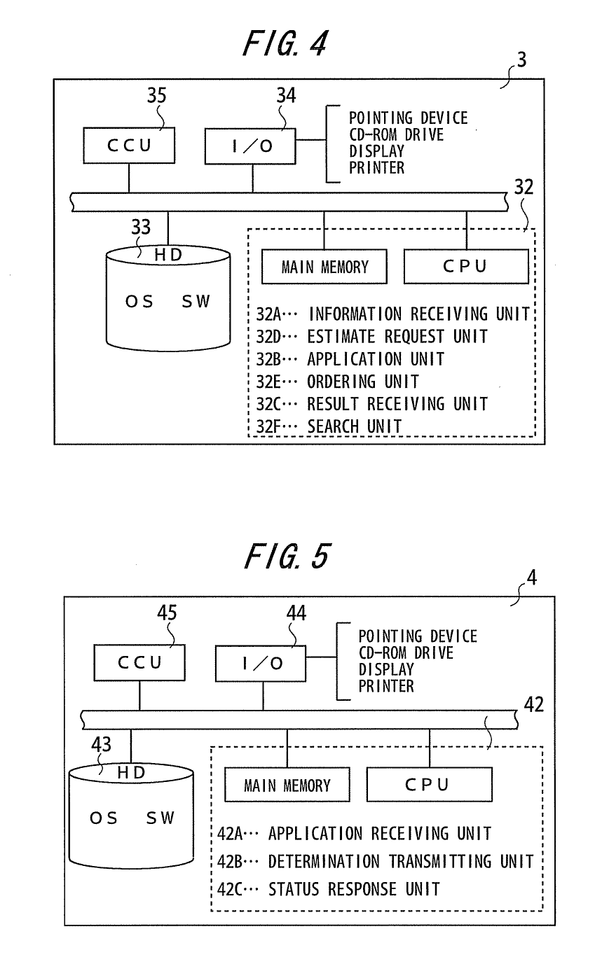

FIG. 4 is a schematic diagram showing the person-in-charge terminal 3. The person-in-charge terminal 3 is a computer including an arithmetic processing unit 32, a storage unit (hard disk) 33 stored with data and software for the arithmetic process, an input/output (I/O) port 34, a communication control unit (CCU) 35, etc.

Properly connected to the I/O port 34 are the input devices (input unit) such as the keyboard, the mouse and the CD-ROM drive and also the output devices such as the display device and the printer.

The CCU 35 controls the communications with other computers via the network.

The storage unit 33 is preinstalled with the operating system (OS) and application software (program).

The arithmetic processing unit 32 constructed of the CPU (Central Processing Unit), the main memory, etc properly reads the OS and the application program from the storage unit 33 and executes the OS and the application program, and arithmetically processes pieces of information inputted from the I/O port 34 and the CCU 35 and the information read from the storage unit 33, thereby functioning also as an information receiving unit 32A, an application unit 32B, a result receiving unit 32C, an estimation request unit 32D, an ordering unit 32E and a search unit 32F.

The information receiving unit 32A receives, as the application information is information containing a value requested for the decision, this application information inputted by a user's operation.

The application unit 32B transmits the application information to the order accepting server 2 or the work consultant server 1 of the management device 6.

The result receiving unit 32C receives result information of an examination about the application information from the management device 6.

The estimation request unit 32D transmits an estimation request signal containing an item of identifying information (e.g., a negotiation ID) to the order accepting server 2 of the management device 6.

The ordering unit 32E transmits ordering information and the order settlement information, which contain a value of a commercial article for ordering and a decision number, to the order accepting server 2 of the management device 6.

The search unit 32F inputs, as keywords, items of information such as the negotiation ID and the decision number that are stored in the data server 5 of the management device 6, and searches the data server 5 for information associated with the keywords.

FIG. 5 is a schematic diagram showing the decider terminal 4. The decider terminal 4 is a computer including an arithmetic processing unit 42, a storage unit (hard disk) 43 stored with data and software for the arithmetic process, an input/output port 44, a communication control unit (CCU) 45, etc.

Properly connected to the I/O port 44 are the input devices such as the keyboard, the mouse and the CD-ROM drive and also the output devices such as the display device and the printer.

The CCU 45 controls the communications with other computers via the network.

The storage unit 43 is preinstalled with the operating system (OS) and application software (program).

The arithmetic processing unit 42 constructed of the CPU (Central Processing Unit), the main memory, etc properly reads the OS and the application program from the storage unit 43 and executes the OS and the application program, and arithmetically processes pieces of information inputted from the I/O port 44 and the CCU 45 and the information read from the storage unit 43, thereby functioning also as an application receiving unit 42A, a decision transmitting unit 42B and a status response unit 42C.

The application receiving unit 42A receives the application information from the management device 6 (the work consultant server 1).

The decision transmitting unit 42B transmits, when the decider inputs the examination result for the application information, this result to the work consultant server 1.

The status response unit 42C transmits, when receiving a query signal from the management device 6, status information representing a status of the decider.

For example, after starting up the computer, a period of time (idle time) for which there is no input from the decider is measured and set as the status information. Further, a schedule of the decider is read from a scheduler and groupware of the decider terminal 4 and may also be set as the status information.

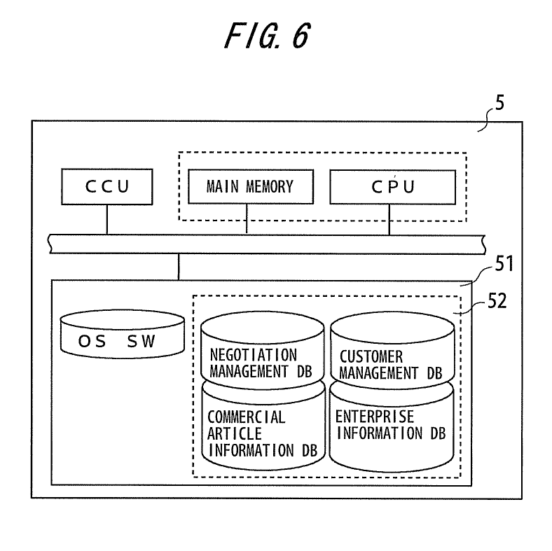

FIG. 6 is a schematic diagram of the data server. The data server 5, which is a computer including a storage unit 51, registers the data received from other devices in the database 52 within the storage unit 51, and provides the data within the database 52 in response to a request given from another device.

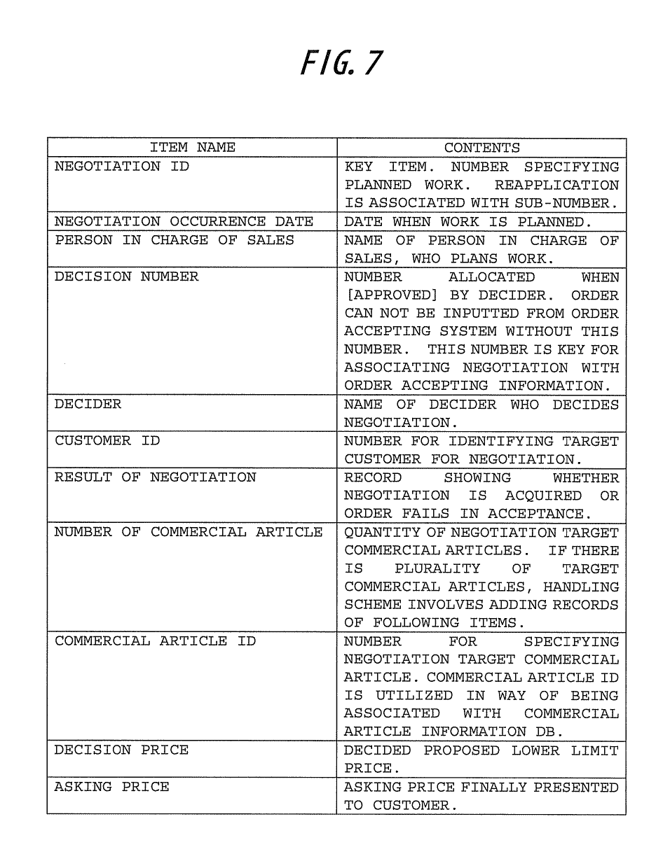

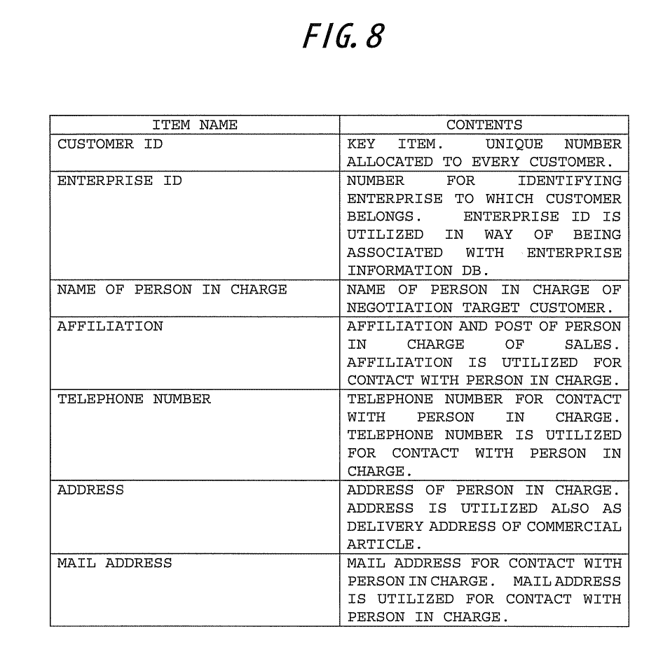

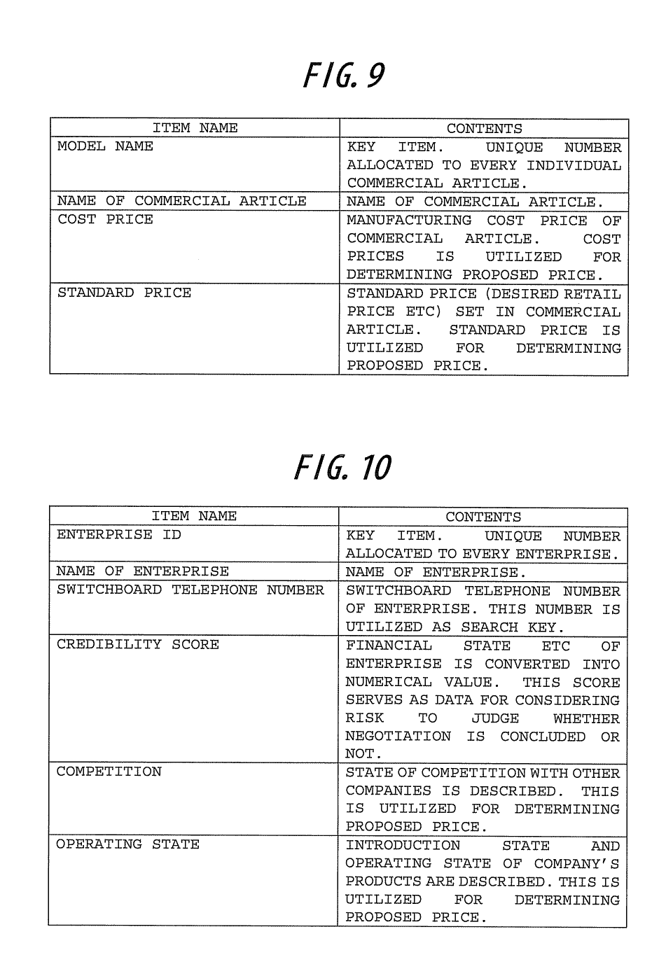

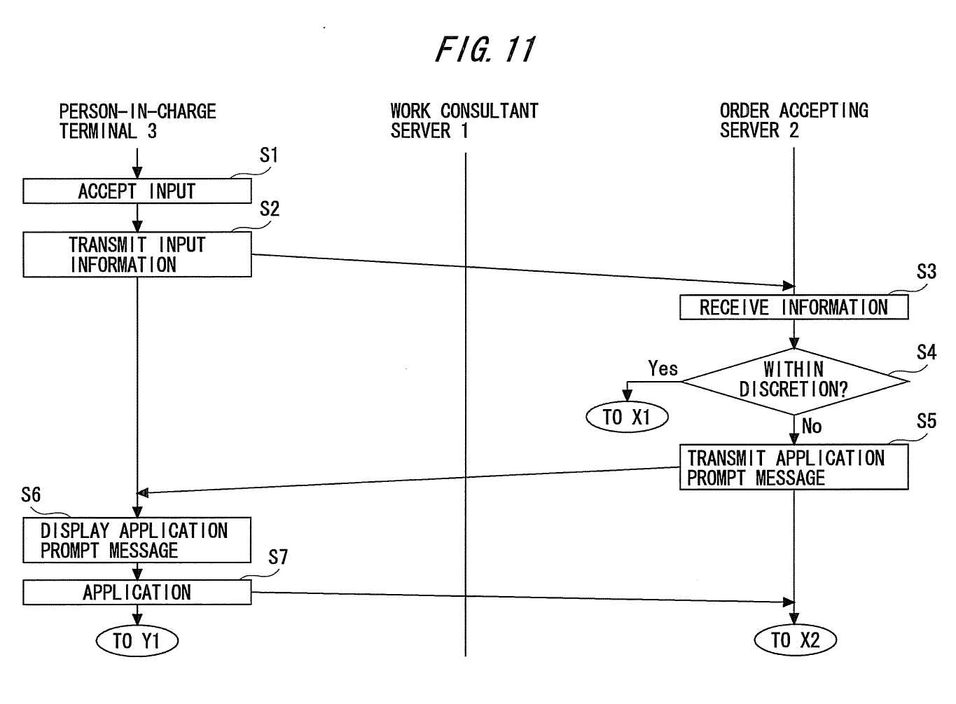

The database 52 in the embodiment has a negotiation management DB (database), a customer management DB, a commercial article information DB and an enterprise information DB. FIGS. 7 through 10 are explanatory diagrams of the management DB, the customer management DB, the commercial article information DB and the enterprise information DB.

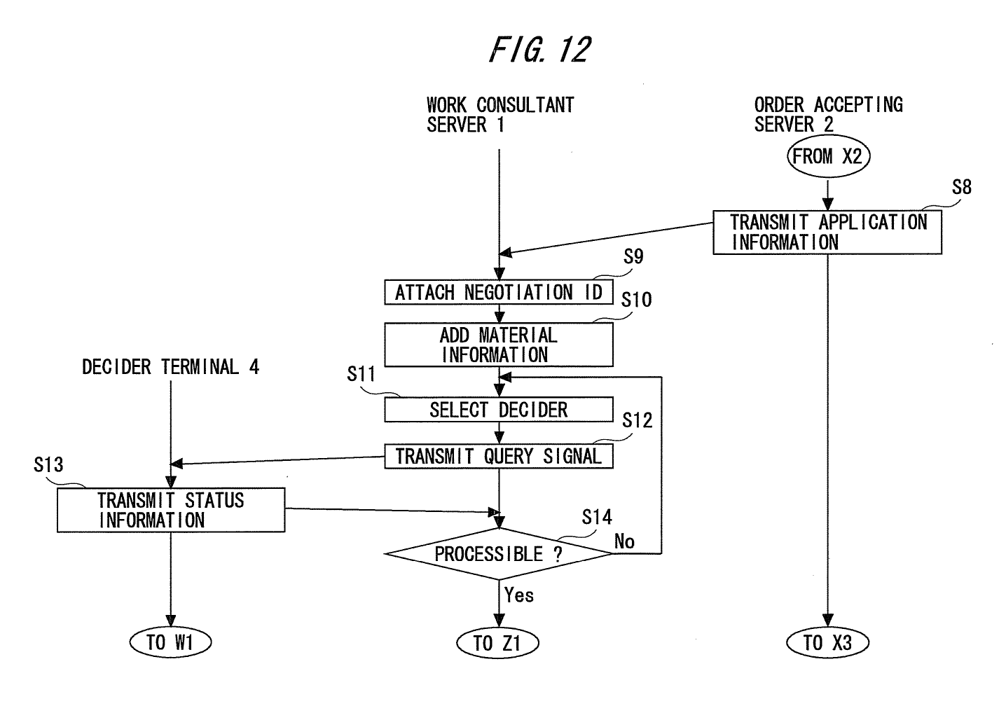

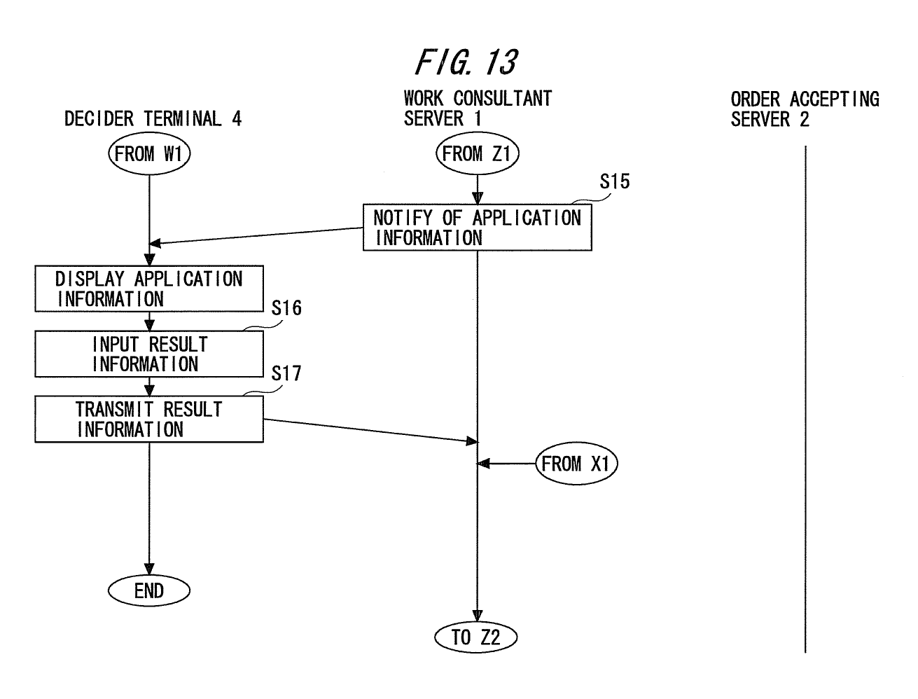

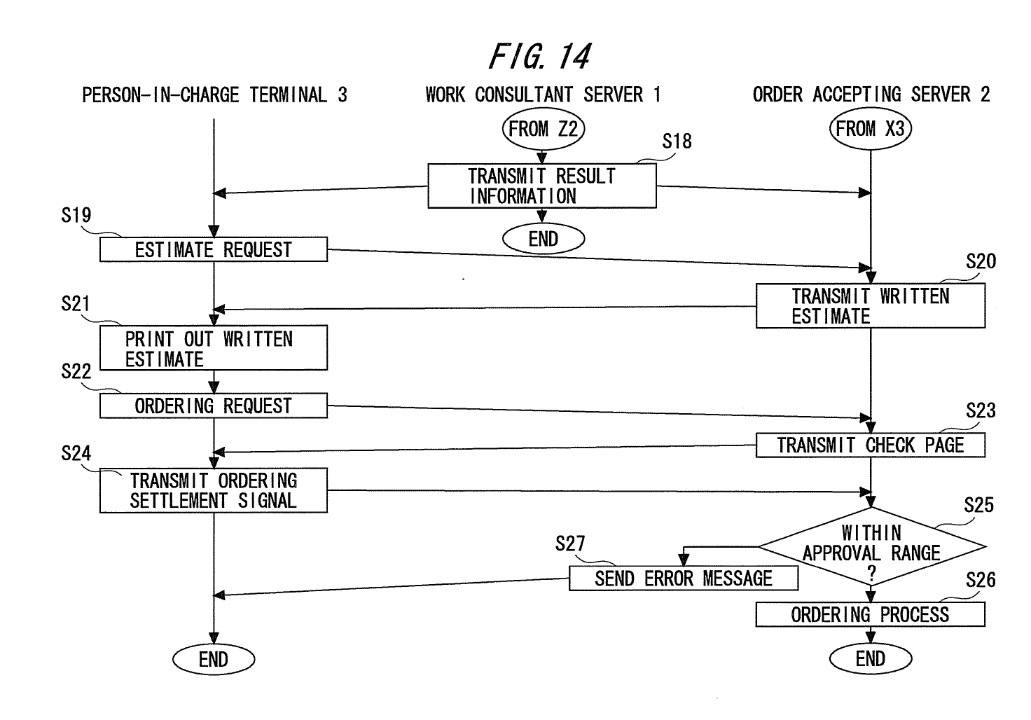

FIGS. 11 through 14 illustrate a work flow management method executed by the work flow management system having these database components.

A person in charge of sales, on the occasion of starting a negotiation for selling the commercial article to the customer, at first creates a written estimate. For this purpose, the person in charge of sales accesses the order accepting server 2 by operating the person-in-charge terminal 3, and transmits information necessary for creating the written estimate.

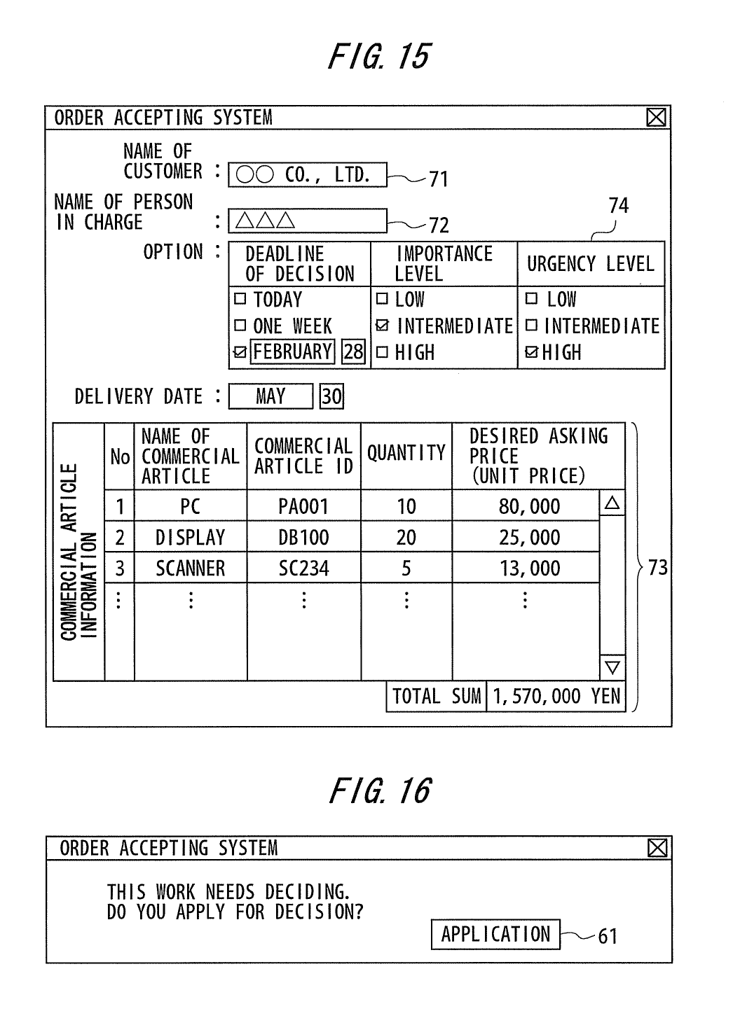

FIG. 15 shows one example of an input form displayed on the person-in-charge terminal 3. The person in charge inputs a name of the customer in an input box 71, a name of the person in charge in an input box 72, names of the commercial articles and desired asking prices in respective rows in an input box 73, and a deadline of decision, an urgency level and an importance level in an input box 74 by operating the keyboard and the mouse. In this configuration, the information receiving unit 32A of the person-in-charge terminal 3 receives the input information by the person in charge (step 1, which will hereinafter be abbreviated such as S1), and the application unit 32B transmits the input information to the order accepting server 2 (S2).

The order accepting server 2 receives the information received from the person-in-charge terminal 3 (S3), and determines whether these items of information are within discretion of the person in charge or not (S4).

For example, the order accepting server 2, if these items of information are applied to predetermined conditions such as whether a total sum of money exceeds a predetermined value or not, the customer is new or not and a discount rate is over a predetermined value or not, determines that the information is beyond the discretion of the person in charge, and transmits and displays a prompt message for the application as illustrated in FIG. 16 to and on the terminal 3 (S5, S6).

When the person in charge presses (selects) an application button 61 for the prompt message, the application unit 32B of the person-in-charge terminal 3 transmits a signal purporting the application for the consultation about the work (the item for discussion) to the order accepting server 2 (S7), and the order accepting server 2 transmits the application information to the work consultant server 1 (S8).

Note that the application information may be, though transmitted from the person-in-charge terminal 3 via the order accepting server 2 to the work consultant server 1 in the embodiment, without being limited to this transmission flow, directly transmitted to the work consultant server 1 from the person-in-charge terminal 3.

The application receiving unit 12D of the work consultant server 1, when receiving the application information, attaches the identifying information (the negotiation ID) unique to every work to the application information (S9). Further, the application receiving unit 12D extracts material information associated with the application information from the database server and adds the material information to the application information (S10).

For instance, items of enterprise information such as a credibility score, competition and an operating status, which are associated with the name of the customer, are extracted from the enterprise information DB, items of actual result information such as a result of past negotiation and a past decision price each associated with the name of the customer are extracted from the negotiation management DB, items of commercial article information such as a cost price and a standard price each associated with a name of the commercial article are extracted from the commercial article information DB, a discount rate of the desired asking price with respect to the standard price is obtained, and these acquired items of information are added as the material information used when examined to the application information.

Then, the selection unit 12E of the work consultant server 1 refers to a decider table, thereby selecting the decider to whom the work (the item for discussion) is assigned corresponding to the customer, the commercial article and the amount of money of the application information (S11).

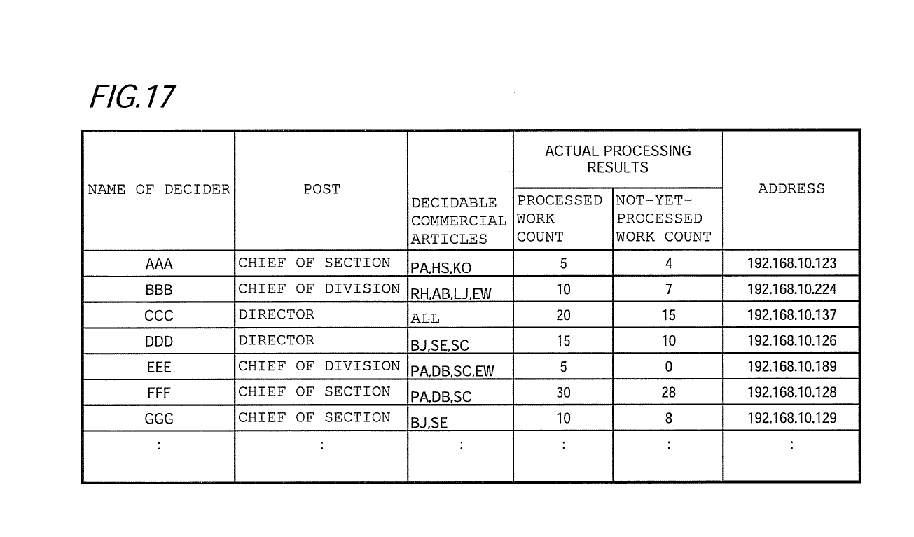

The decider table in the embodiment is stored with a post (class) of the deciders, a decidable commercial article (authority), an actual processing result, an address, etc as shown in FIG. 17. Then, the selection unit 12E obtains, from the decider table, the decider having the post (class) corresponding to the amount of money and the importance level of the application information based on a predetermined associated relationship, such as determining a chief of a section if the total sum of money of the application is less than 1,000,000 Yen, a chief of a division if less than 5,000,000 Yen, a director if equal to or larger than 100,000,000 Yen, and further the chief of the section if the importance level is low, the chief of the division if intermediate, and the director if high.

Moreover, in the embodiment, the commercial article ID is organized by a code representing a category (genre) of the commercial article and a number specifying each commercial article in the category, and the decider table is stored with the individual deciders and the codes of the decidable commercial articles in a way that associates the deciders with the codes.

Therefore, for example, if the commercial article ID of the application information is “PA001”, the selection unit 12E obtains, from the decider table, the decider CCC and the decider EEE each having the post (class) capable of deciding a total sum of money 1,570,000 Yen among the decider AAA, the decider CCC, the decider EEE and the decider FFF each associated with the code “PA”.

Further, the decider table is stored with the number of works (a processed work count) processed within a predetermined period of time and the number of not-yet-processed works (not-yet-processed work count) as an actually processing result. Therefore, for instance, the selection unit 12E refers to the decider table, and executes a load sharing process by selecting the deciders so as to equalize the processed work counts by the individual deciders within the predetermined period such as intervals of one day, one week, etc. Moreover, if the urgency level is equal to or higher than a predetermined level, or if intermediate or high, there are obtained the deciders showing that the not-yet-processed work count is less than a predetermined count, and, for example, the decider EEE showing that the not-yet-processed work count is less than “5” in the deciders CCC and EEE may be selected.

Thus, the selection unit 12E selects the decider to whom the work is assigned by using any one of the conditions or by combining a plurality of conditions. For example, if there is the plurality of deciders associated with the amount of money and the commercial article of the application information, the decider showing the minimum processed work count or the minimum not-yet-processed work count is selected.

Then, for checking the present status of the selected decider, the check unit 12F transmits a query signal to an address of the decider (S12).

In the decider terminal 4 receiving the query signal, the status response unit 42C refers to the idle time and the schedule, and transmits the status information to the work consultant server 1 (S13).

The check unit 12F of the work consultant server 1 receiving the status information determines based on the status information whether the work can be processed or not (S14). For example, if applied to predetermined conditions such as there being a business trip and a vacation scheduled up to the deadline, 50% or more of the working time up to the deadline being scheduled, the urgency level being high, or the idle time exceeding one hour though on the very day, the check unit 12F determines that the time for processing the work can not be taken (the process is determined to be disabled). Further, after transmitting the query signal, if there is no response within a predetermined period of time, i.e., if there is no log-on to the system, the process is determined to be disabled.

Then, if the process is determined to be disabled, the operation loops back to step 11, in which the decider is reselected by excluding the decider about which the process is determined to be disabled.

On the other hand, if the status information is not applied to the predetermined conditions in step 14, the process is determined to be enabled, and the notifying unit 12A notifies the decider terminal 4 of the application information (S15). For example, the notifying unit 12A transmits the application information to the decider terminal 4 according to the address in the decider table. Another available scheme is that the notifying unit 12A stores the application information in a storage area of the work consultant server 1 or another device, and the decider terminal 4 reads the application information by periodically accessing the address specifying the storage area and thus notifies of the application information.

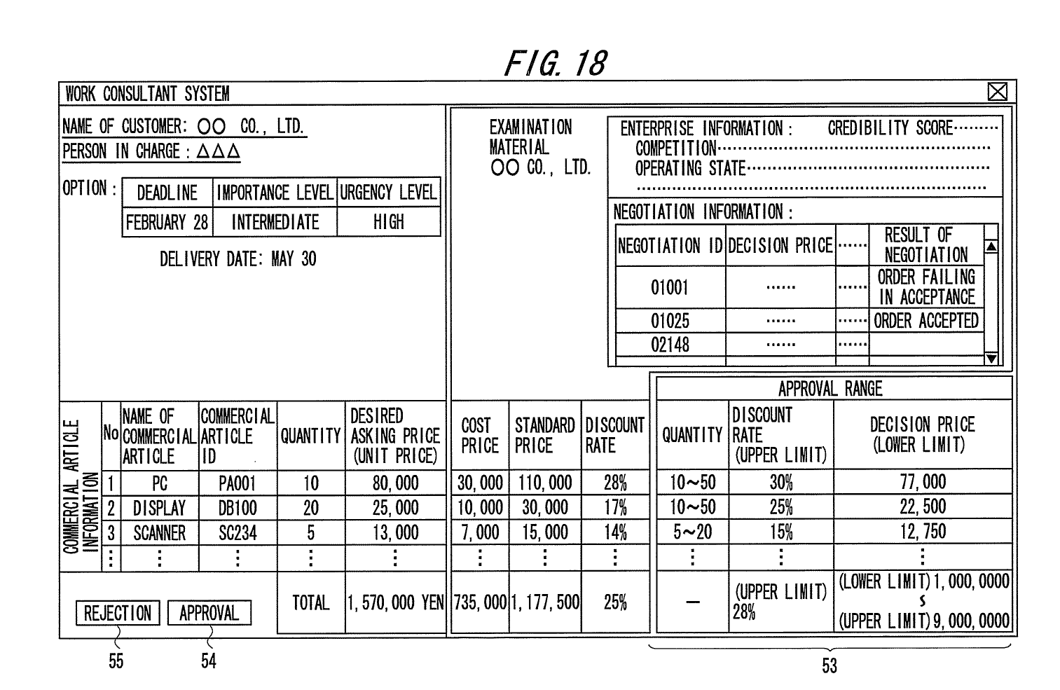

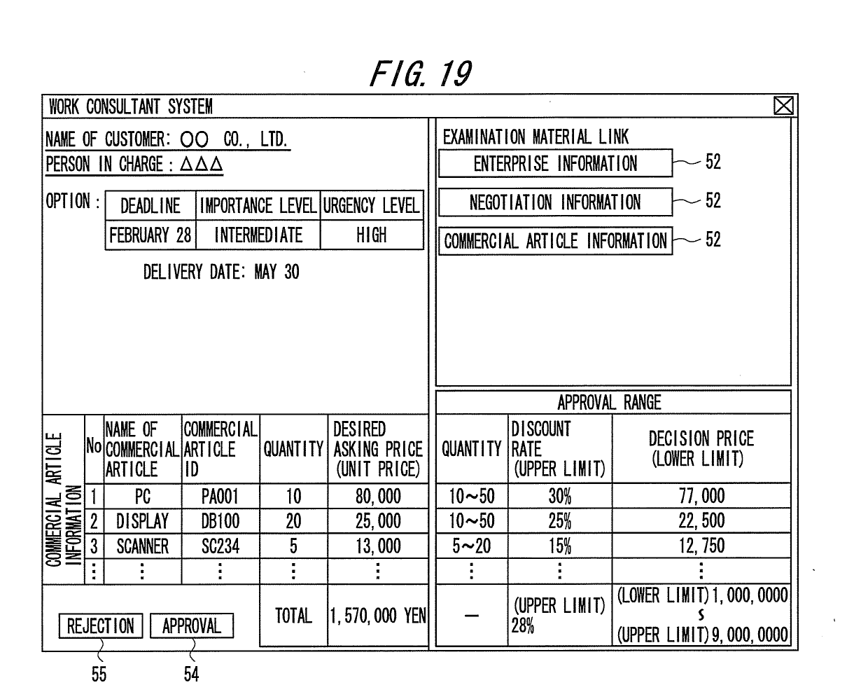

The decider terminal 4 receiving the application information displays, as illustrated in FIG. 18, the application information on the display unit. FIG. 18 shows a display example in a state of adding the items of material information such as the enterprise information, the commercial article information and the actual result information, however, as illustrated in FIG. 19, still another available scheme is that only basic items of information such as the customer name and the desired asking price of the application information are displayed, and the material information is displayed by pressing (selecting) a link button 52. In this case, the addition of the material information to the application information may be omitted in step 10.

The decider examines the application information while seeing the displayed application information, then, if approving the application information, inputs ranges of values of a decision price, a quantity, a deadline for delivery and a term of validity of the approval to the input box 53, and selects an approval button 54. Further, if not approved, the decider selects a rejection button 55. In this case, a reason for the rejection may also be inputted. The decider terminal 4 receiving the input (S16) by the decider transmits, back to the work consultant server 1, an approval signal containing the range of the value to be approved or a rejection signal properly containing the rejection reason and the identifying information of the work as the result information (S17). Incidentally, if the input information is within the range of the discretion of the person in charge, the decision is not required, then the order accepting server 2 transmits the approval signal (the result information) to the work consultant server 1, and hereafter the work is dealt with similarly to the already-approved work. In this case, the ranges of the values of the price, the quantity, etc are inputted within the range of the discretion of the person in charge.

The result transmission unit 12C of the work consultant server 1 transmits the received result information to the person-in-charge terminal 3 defined as an applicant terminal and to the order accepting server 2 (S18). If the result information contains the approval signal, the decision number is attached thereto. Note that the decision number connotes the number enabled to uniquely specify the approved work. Further, the work consultant server 1 transmits the result information to the data server 5, in which the negation result, the decision number, the decision prices, etc are registered in a record of the negotiation management DB, the recording being associated with the identifying information of the result information.

When the person-in-charge terminal 3 receives the result information, the person in charge proceeds along the negotiation based on this decision result.

For example, if approved, the written estimate is requested. The estimation request unit 32D of the person-in-charge terminal 3 transmits a written estimate request signal containing the decision number of the work to the order accepting server 2, corresponding to an operation of the person in charge (S19). The estimation unit 22C of the order accepting server 2 receiving the request signal generates a written estimate file in which the name of the customer, the name of the commercial article, the desired asking price, etc of the application information associated with the decision number contained in the request signal are laid out in a predetermined format, and transmits the written estimate file to the person-in-charge terminal 3 (S20).

The person-in-charge terminal 3, which has received the written estimate file prints out the written estimate based on the received written estimate file (S21).

The person in charge presents the written estimate to the customer and, if a further discount and a change of the quantity are required, proceeds along the negation within the range of the result information.

Then, if the negotiation is settled, the person in charge executes the ordering process in a way that designates the decision number of the work by operating the person-in-charge terminal 3. The person-in-charge terminal 3, corresponding to this operation, accesses the order accepting server 2 and transmits the order information containing the decision number (S22).

The order accepting server 2 receiving the order information reads the application information and the result information each associated with the decision number, transmits and displays a confirmation page describing the items of information such as the name of the customer, the desired asking price, the name of the commercial article, the discount rate and the range of the approved value to and on the person-in-charge terminal 3 (S23).

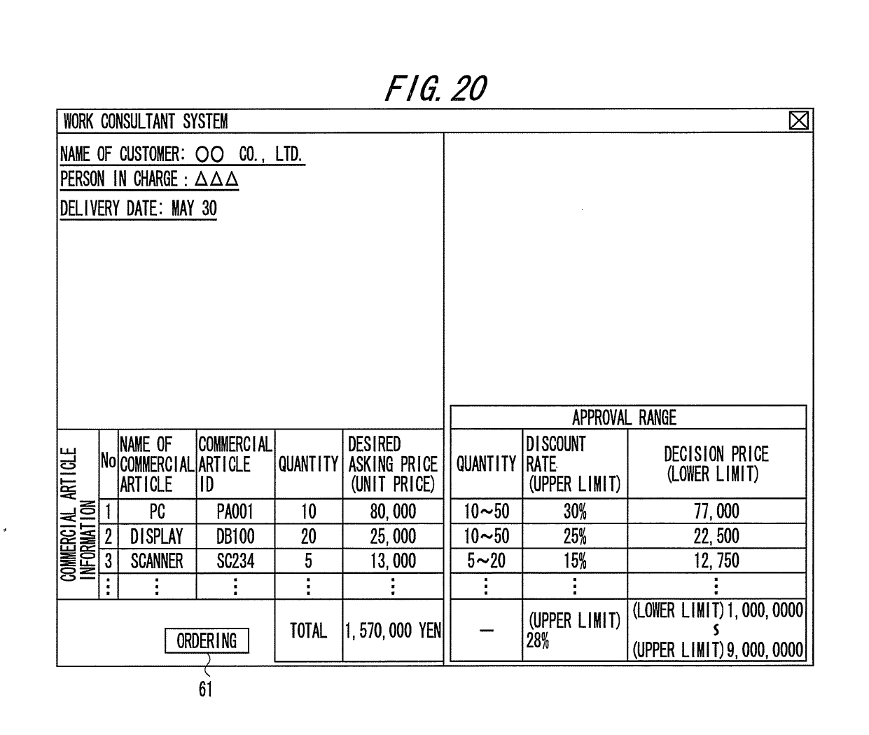

FIG. 20 is a diagram showing an example of a modification page. In the case of giving the order with these contents, the person in charge selects an ordering button 61. Further, in the case of modifying the values of the price, the quantity, the appointed date for delivery, etc, the ordering button 61 is selected after changing the values of the respective input boxes.

With this operation, the ordering unit 32E of the person-in-charge terminal 3 transmits the order settlement information containing the values registered in the respective input boxes and the decision number to the order accepting server 2 (S24).

When the order accepting unit 22A of the order accepting server 2 receives the order settlement information, the order acceptance processing unit 22B determines whether or not the values of the prices and the quantity contained in the ordering signal are within the approved ranges in the result information associated with the decision number (S25).

When determining that these values are within the approved ranges, the order acceptance processing unit 22B executes the order accepting process (S26). The order accepting process involves, e.g., transmitting the commercial article ID, the quantity, the appointed date for delivery, etc as the ordering information to the computer defined as an ordering computer. Moreover, papers such as an ordering slip, a bill and an invoice of the commercial article are output. Further, the information purporting that the order has been accepted is registered as a result of the negotiation in the negotiation management DB. Furthermore, the values of the asking price, the quantity, etc, which are changed when accepting the order, are registered in the negotiation management DB.

While on the other hand, if the values of the price and the quantity are beyond the ranges approved by the result information associated with the decision number in step 25, the order accepting process is inhibited, i.e., without executing the order accepting process, an error message purporting that the values are beyond the approved ranges is sent to the person-in-charge terminal 3 (S27).

Note that when the person-in-charge terminal 3 transmits the signal showing a purport of failing to accept the order and the identifying information thereof to the order accepting server 2, and when the ordering signal is not received within the term of the validity of the decision, the order acceptance processing unit 22B registers, as a failure to accept the order, the result of the negotiation about the work specified by the identifying information in the negotiation management DB.

If the negotiation is not concluded within the approval ranges, the person in charge makes the application once again. At this time, the identification number, the name of the commercial article, the name of the customer, etc of the last time are inputted, whereby the search unit 32F of the person-in-charge terminal 3 searches for the data in the data server 5, thus reading and displaying the past works.

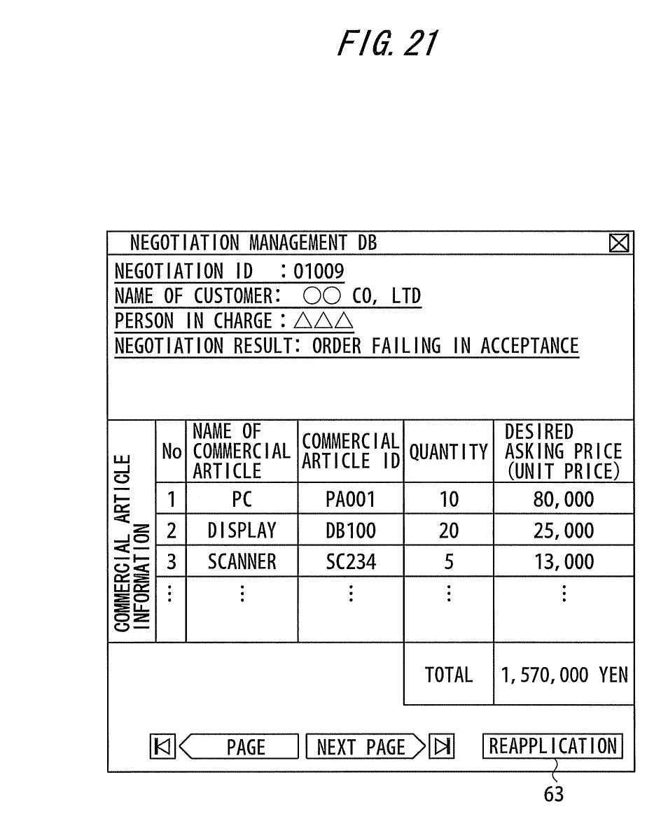

FIG. 21 shows an example of displaying the past works. If a want-to-reapply-work is detected from within the readout works, the person in charge presses a reapplication button 63. With this operation, the person-in-charge terminal 3 displays the application form, and copies the items of information on the work to the respective input boxes.

The input values of the desired asking price etc in the application form are properly changed, then the application button 61 is selected, and the processes from step 7 onward are repeated. With this scheme, planning is done by making use of the past examples, thereby enabling the input operation by the person in charge to be reduced.

Note that if a plurality of applications for one single work (the item for discussion) is made, i.e., if the reapplication is made based on the previous application information, a sub-number is attached to the negotiation ID of the basic application information, then a negotiation ID of the reapplication information is generated in a way that changes the sub-number each time the reapplication is made, and the information may be managed by associating these items of information with each other. For example, the related works are acquired by extracting the works of which the data excluding the sub-numbers of the negotiation IDs are coincident, and displayed as a list, thus helping the operation by the person in charge of the decision. On this occasion, values different from those in the application of the last time are emphatically so displayed as to be highlighted, which is effective to the decider.

As discussed above, according to the embodiment, only when approved, the order accepting process can be executed, and hence the person in charge can be prevented from giving an illicit order.

Then, even with the scheme preventing the order to be issued unless approved, the order can be given if changed within the range of the changeable values by setting this range when approved, thereby eliminating such a time-consuming operation that a minute change entails making the reapplication.

In other words, the decided price is dealt with not directly as the negotiation price but as a [lower limit] of the asking price, thereby providing a chance to the person in charge of sales for negotiating at a much higher sales price and making it easier to ensure profits.

Moreover, a width of the discretion is given to each individual person in charge, the order can be accepted if within this range without making the application, and the approval is indispensable only if over the range, thereby reducing an occurrence frequency of the work application and enabling both of the prevention of illicit order and the higher efficiency in operation to be compatible.

Moreover, the management device associates the application information with the negotiation examples, the enterprise information and the commercial article information that are registered in the data server 5, whereby the information inputted when planning the work can be narrowed down to the minimum required, and the load on the person in charge of the sales can be reduced. Further, the cost price information of the commercial article and the information on the credibility score of the customer enterprise can be surely presented, thereby making it possible to help the examination by the decider and to realize the higher efficiency of the operation.

Moreover, the works can be prevented from stagnating due to absence of the decider. Moreover, the works can be adequately allocated corresponding to the classes (posts) and the authority of the deciders.

Still further, it is feasible to prevent the loads to be concentrated, corresponding to schedules of the deciders and the work count.

Yet further, the selection of the decider in charge of examining the work and the priority level in the decision can be controlled based on the importance level and the urgency level.

Additionally, the negotiation management DB is stored with the information showing the results of the negotiations, i.e., the orders accepted or the orders failing in the acceptance, and it is therefore feasible to grasp a tendency of the works of the orders could be accepted and a tendency of the works of the orders failed in acceptance. Further, the order-accepted works are extracted for the use in the reapplication, whereby the applications can be made under the precise conditions.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A work flow management system comprising:
a person-in-charge terminal; and
a management device,
the person-in-charge terminal including:
an input unit receiving an input of information containing a value requested for decision through an operation by a person in charge;
an application unit transmitting the inputted information as application information to the management device; and
a result receiving unit receiving result information of an examination about the application information from the management device,
the management device including:
a notifying unit notifying a decider of the application information received from the person-in-charge terminal;
a result accepting unit receiving an input of the result information containing a range in which at least the application information can take a value when approving the application information through the operation of the decider; and
a result transmitting unit transmitting the result information to the person-in-charge terminal.

2. The work flow management system according to claim 1, wherein the person-in-charge terminal includes an ordering unit transmitting order information containing identifying information for specifying the result information to the management device, and
the management device includes: an order accepting unit receiving the order information from the person-in-charge terminal; and an order acceptance processing unit executing an order accepting process within a value range of the result information by referring to the result information associated with the identifying information of the order information.

3. The work flow management system according to claim 2, wherein when the management device receives a change signal showing a purport of changing the value of the application information from the ordering unit of the person-in-charge terminal, the order acceptance processing unit executes the order accepting process if the value to be modified is within the range of the result information but inhibits the order accepting process if the value to be modified is beyond the range.

4. The work flow management system according to claim 1, wherein the management device includes a selection unit connected to a plurality of decider terminals of the deciders, and selecting the decider conforming to the application information by referring to a decider table registered with information of the individual deciders, and the notifying unit notifies the decider terminal of the selected decider of the application information.

5. A work flow management method executed by a system comprising a person-in-charge terminal and a management device, wherein the work flow management method causes the person-in-charge terminal to execute:
receiving an input of information containing a value requested for decision through an operation by a person in charge;
transmitting the inputted information as application information to the management device; and
receiving result information of an examination about the application information from the management device; and
causes the management device to execute:
notifying a decider of the application information received from the person-in-charge terminal;
receiving an input of the result information containing a range in which at least the application information can take a value when approving the application information through the operation of the decider; and
transmitting the result information to the person-in-charge terminal.

6. The work flow management method according to claim 5, wherein the person-in-charge terminal transmits order information containing identifying information for specifying the result information to the management device, and
the management device receives the order information from the person-in-charge terminal, and executes an order accepting process within a value range of the result information by referring to the result information associated with the identifying information of the order information.

7. The work flow management method according to claim 6, wherein the management device, when receiving a change signal showing a purport of changing the value of the application information from the person-in-charge terminal, executes the order accepting process if the value to be modified is within the range of the result information but inhibits the order accepting process if the value to be modified is beyond the range.

8. The work flow management method according to claim 5, wherein the management device connects to a plurality of decider terminals of the deciders, then selects the decider conforming to the application information by referring to a decider table registered with information of the individual deciders, and notifies the decider terminal of the selected decider of the application information.

9. A management device connected to a person-in-charge terminal, comprising:
a notifying unit notifying a decider of the application information received from the person-in-charge terminal;
a result accepting unit receiving an input of the result information containing a range in which at least the application information can take a value when approving the application information through the operation of the decider; and
a result transmitting unit transmitting the result information to the person-in-charge terminal.

10. The management device according to claim 9, further comprising:
an order accepting unit receiving the order information from the person-in-charge terminal; and
an order acceptance processing unit executing an order accepting process within a value range of the result information by referring to the result information associated with the identifying information of the order information.

11. The management device according to claim 10, wherein when receiving a change signal showing a purport of changing the value of the application information from the ordering unit of the person-in-charge terminal, the order acceptance processing unit executes the order accepting process if the value to be modified is within the range of the result information but inhibits the order accepting process if the value to be modified is beyond the range.

12. The management device according to claim 9, further comprising a selection unit connected to a plurality of decider terminals of the deciders, and selecting the decider conforming to the application information by referring to a decider table registered with information of the individual deciders, and
the decider terminal of the selected decider is notified of the application information.

13. A storage medium readable by a computer, storing a work flow management program operated by a management device connected to a person-in-charge terminal and making the management device execute:
notifying a decider of the application information received from the person-in-charge terminal;
receiving an input of the result information containing a range in which at least the application information can take a value when approving the application information through the operation of the decider; and
transmitting the result information to the person-in-charge terminal.

14. The storage medium readable by a computer according to claim 13, further making the management device execute: receiving the order information from the person-in-charge terminal; and
executing an order accepting process within a value range of the result information by referring to the result information associated with the identifying information of the order information.

15. The storage medium readable by a computer according to claim 14, wherein when receiving a change signal showing a purport of changing the value of the application information from the person-in-charge terminal, the order accepting process is executed if the value to be modified is within the range of the result information but is inhibited if the value to be modified is beyond the range.

16. The storage medium readable by a computer according to claim 13, wherein the decider conforming to the application information is selected by referring to a decider table registered with information of the individual deciders in a way that connects to a plurality of decider terminals of the deciders, and the decider terminal of the selected decider is notified of the application information.
